(19) United States
(12) Patent Application Publication
(10) Pub. No.: US 2026/0172425 A1
(43) Pub. Date: Jun. 18, 2026

(54) PROFILE GRANTS FOR GRANTING PERMISSIONS FOR TOOL ACCESS

(71) Applicant: ZILLA SECURITY, INC., Boston, MA (US)

(72) Inventors: Daniel PETERSON, Grafton, MA (US); John H. O'NEIL, Belmont, MA (US); Nitin SONAWANE, Belmont, MA (US)

(73) Assignee: ZILLA SECURITY, INC., Boston, MA (US)

(21) Appl. No.: 19/409,201

(22) Filed: Dec. 4, 2025

Related U.S. Application Data
(60) Provisional application No. 63/727,813, filed on Dec. 4, 2024.

(51) Int. Cl. H04L 9/40

(52) U.S. Cl. CPC H04L 63/102; H04L 63/104; H04L 63/105

(57) ABSTRACT

A method for controlling access to a resource in a resource set includes, for each member of an organization, retrieving a member-attribute set and a member-permission set. The member-attribute set includes attributes of the member and the member-permission set includes a permission that indicates whether that member is entitled to use that resource. The method continues with defining a global attribute-set and defining a set of profiles. The global attribute-set is a union of the member-attribute sets and each profile is a proper subset of the global attribute-set. Each profile has a profile population that consists of those members whose attributes are a superset of those in the profile. These profiles, in aggregate, cover a predefined fraction of the members.

### CROSS-REFERENCE TO RELATED APPLICATION

This application claims the benefit of priority to U.S. Provisional Patent Application No. 63/727,813 filed on Dec. 4, 2024, the entire contents of which are incorporated by reference in this application.

### TECHNICAL FIELD

The present disclosure relates to the field of managing user permissions for resources. In particular, and without limitation, the disclosure pertains to creating and granting profile-based permissions for resources on computers.

### BACKGROUND

Managing user access for resources on computers and keeping permissions up to date as users change roles, leave the company, or move up in level can prove to be very challenging. Year-to-year, considerable resources are spent on organizing profiles and permissions, implementing the profiles and permissions, and monitoring profiles and permissions to ensure that each user/member of the organization has access to all of the resources they need, but do not have access to any resources to which they should not have access or do not need access to. In many scenarios, over allowing access to resources that a member of an organization does not need can drive up operational costs, and can lead to concerns with security of data, when more people have access to a subset of the organization's resources, but operationally do not need them.

To better understand the gravity of the problem, it may be helpful to understand how each of the pieces fit together. An organization comprises members who work for a common cause. These members typically perform different tasks in furtherance of that cause. As a result, different members of the organization will access and use different resources to perform different tasks.

In principle, one could provide all members of the organization with equal access to all resources. However, this arrangement has many disadvantages as discussed above. As a result, it is usual to permit only those members who need and should be allowed a resource to access that resource. This provides control over access to sensitive resources and discourages misuse either by members of the organization, former members, or unrelated parties who seek to cause mischief.

To ensure that all members have only the correct resources, it is good practice to periodically audit the organization. It has been found that such audits turn up many errors. These errors appear to arise because what seems like a simple administrative task scales non-linearly in complexity as the organization's size increases and also as the number of possible keys increases. A key may refer to an authorization or permission to access a resource-wherein, when a member has an access right or an authorization to use a resource, they have the key to that resource. For medium-sized organizations, there can be thousands of employees and thousands of permission levels for accessing the organization's resources. This leads to a combinatorial explosion, in which there can easily be millions or tens of millions of discrete user permissions. To make matters worse, the population of the organization's resource-set which typically include software resources, such as applications, platforms, databases, cloud apps, data-lakes or on-prem applications, changes on a regular basis.

As a result, preparing for what should be a routine audit can consume a great deal of time. Moreover, errors in assigning keys to members can be costly, both financially and in terms of exposure, loss of information or any other security related risks. While preparation and running of audits are expensive, so is the work on the back-end, updating each person's permissions based on what was found in the audit, and making sure that the errors that have been flagged are resolved as quickly as possible.

Existing methods of managing keys include role-based access control. In this method, one creates “roles” and assigns different roles to different employees. However, this merely changes the problem. One must still create and update these roles. In addition, one must delete roles that are no longer in use. Current solutions leave a considerable gap in the market, with minimal access to solutions that are dynamic, or capable of mapping employees to resources using complex data processing tools. These current solutions thus require significant bandwidth and processing power for both development and maintenance of permissions to use one or more resources. Furthermore, auditing the permissions still provides challenges. The complexity of the audit increases proportionally with the amount of human interaction required for developing and permissioning users. There is thus a need for solutions that enable permissions to be managed more effectively, streamlining both the permissioning process and improving efficiencies in auditing, with less human dependencies,

### SUMMARY

In one aspect, a method for controlling access to a resource is disclosed. The method includes, for each member of an organization, identifying a user-attribute set and a user-permission set. The user-attribute set includes attributes of the user and the user-permission set includes a permission that indicates whether that user is entitled to use that resource. The method includes defining a global attribute-set and determining, using a machine learning model, a set of profiles. The global attribute-set is a union of the user-attribute sets and each profile is a subset of the global attribute-set. Each profile has a profile population that consists of those members whose attributes are a superset of those in the profile. These profiles, in aggregate, cover a predefined fraction of the members.

The method includes selecting candidate profiles from the foregoing set of profiles. For each such candidate profile, the method includes generating a “profile grant.” The profile grant grants, to each member in the candidate profile's population, entitlement to use the resource. The method includes assigning the entitlement to the user based on the first profile grant.

In another aspect, the method includes using a machine learning model and receiving information indicating that a member-permission set of a member requires processing. This processing is either the creation of a member-permissions set or the modification of an existing member-permission set. The latter may be viewed as a special case in which one creates a new member-permissions set that replaces the old one. The method may also include selecting a profile grant based on that member's member-attribute set and using the selected profile grant to process the member-permission set.

In another aspect, the method includes selecting the candidate profiles is based at least in part on entitlement counts of the candidate profiles.

In another aspect, the method includes selecting the candidate profiles is based at least in part on a birthright fractions of the candidate profiles.

In another aspect, the method includes selecting the candidate profiles includes selecting the candidate profiles based at least in part on minimum entitled populations of the candidate profiles.

In another aspect, the method includes selecting the candidate profiles includes selecting the candidate profiles based at least in part on the false-alarm rates of the candidate profiles.

In another aspect, the method includes selecting the candidate profiles includes disqualifying a profile from being a candidate profile based on the profile having a particular attribute and those in which candidate profiles are selected based on a limit on the number of profile grants.

In another aspect, the method includes selecting candidate profiles includes ranking profile grants derived from the candidate profiles and selecting only those candidate profiles whose profile grants are above a threshold rank and those in which selecting candidate profiles includes scoring profile grants derived from the candidate profiles and selecting only those candidate profiles whose profile grants are above a threshold score.

In another aspect, the method includes selecting candidate profiles includes selecting the candidate profiles to minimize overlap of profile grants that result from the selection.

The methods described herein cannot be executed on a generic computer. As such, a non-generic computer is required. In addition, it has been found that the methods described herein cannot be practicably performed in the human mind.

This disclosure describes only non-abstract ways of carrying out the method. All claims are therefore to be construed as covering only non-abstract implementations. Any person who construes the claims to cover abstract subject matter is therefore construing the claims in a manner contrary to the specification. As used herein, “non-abstract” means the converse of “abstract” as that term has been defined by the courts of the United States as of the filing date of this application.

### BRIEF DESCRIPTION OF THE FIGURES

FIG. 1 is a block diagram illustrating an example system environment for assigning permissions to an organization's members by using profile grants, consistent with the disclosed embodiments.

FIG. 2A is a block diagram showing an example server, consistent with the disclosed embodiments.

FIG. 2B is a block diagram showing an example computing device, consistent with the disclosed embodiments.

FIG. 3 shows a block diagram of an exemplary system that assigns permissions to an organization's members by using profile grants.

FIG. 4 illustrates an exemplary method for generating member permissions based on profiles.

FIG. 5 illustrates an exemplary method for determining member permissions and granting permissions based on profiles.

### DETAILED DESCRIPTION

The designed system operates on file-based input and output to offer maximum flexibility to its statistical engine. As input, a request file gives the statical engine instructions about what data to use and how to interpret it. As a file based output, the statistical engine offers a stateless response that assumes no existing customer configuration as well as a stateful response that considers as input previous responses. Using this file based approach, the system can provide stateful responses, stateless responses as well as offer a comprehensive history of the system's calculations over time. The processing performed by the disclosed system produces a set of clusters of users that share similar user metadata to determine a set of entitlements for these users. The system allows for the size and significance of these clusters to be influenced by the organization

The techniques for generating attribute-based permissions described herein overcome several technological problems relating to security, efficiency, and performance in the fields of cybersecurity and network security. As discussed above, attackers may infiltrate a network by assuming an identity of a network user. It may be difficult, if not impossible, to distinguish the permissions of organization employees versus those that should not have access to resources. Additionally, audits become increasingly difficult to perform as organization size increases and more resources are supported. More efficient and accurate audits save resources and ensure that high security and privacy is maintained amongst throughout an organization and beyond. To address these forms of security risks and efficiency issued, the disclosed techniques may dynamically monitor user permissions and using a trained machine learning model optimize how permissions are granted. For example, many generative AI technologies like ChatGPT™, Bard™, Claude™, and others offer tools for analyzing user attributes and optimize information to determine profiles that users can be identified by, indicating what permissions they should be granted. By leveraging these or other forms of AI tools, the disclosed techniques may automatically detect or predict which permissions each user should have.

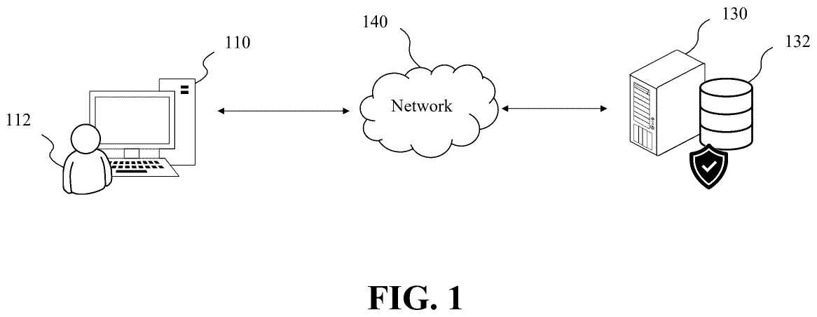

FIG. 1 illustrates an example system environment 100 for assigning permissions to an organization's members by using profile grants, consistent with the disclosed embodiments. System environment 100 may include one or more computing devices 110, and one or more servers 130, as shown in FIG. 1. It should be understood that system environment may include fewer or additional computing devices and/or servers. In some embodiments, assigning permissions using profile grants may include network-based operations. For example, this may include one or more operations performed using computing device 110 involving a file or other data on server 130 or database 132. Alternatively, some or all of the computational activity may occur locally. For example, the local computing operation may be an operation involving a file stored in computing device 110. Accordingly, while system environment 100 is shown in FIG. 1 to include server 130 separately from computing device 110 by way of example, in some embodiments, server 130 may be integrated with computing device 110. For example, server 130 may be a process running on computing device 110. Accordingly, system environment 100 may not necessarily be a network-based system environment and may be a local environment of computing device 110.

The various components of system environment 100 may communicate over a network 140. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth™M, infrared, etc.), or various other types of network communications. In some embodiments, the communications may take place across two or more of these forms of networks and protocols. While system environment 100 is shown as a network-based environment, it is understood that in some embodiments, one or more aspects of the disclosed systems and methods may also be used in a localized system, with one or more of the components communicating directly with each other.

As noted above, system environment 100 may include one or more computing devices 110. Computing device 110 may include any device that may be used for engaging in a managed session. Accordingly, computing device 110 may include various forms of computer-based devices, such as a workstation or personal computer (e.g., a desktop or laptop computer), a mobile device (e.g., a mobile phone or tablet), a wearable device (e.g., a smart watch, smart jewellery, implantable device, fitness tracker, smart clothing, head-mounted display, etc.), an IoT device (e.g., smart home devices, industrial devices, etc.), or any other device that may be capable of performing a privileged computing operation. In some embodiments, computing device 110 may be a virtual machine (e.g., based on AWS™, Azure™, IBM Cloud™, etc.), container instance (e.g., Docker™ container, Java™ container, Windows Server™ container, etc.), or other virtualized instance.

In some embodiments, computing device 110 may be associated with an identity 112. Identity 112 may be any entity that may be associated with one or more privileges or permissions to perform a privileged computing operation. For example, identity 112 may be a user, an account, an application, a process, an operating system, a service, an electronic signature, or any other entity associated with one or more components of system environment 100. In some embodiments, identity 112 may be a user requesting to perform various operations, which may include accessing data stored in computation device 110, server 130, and/or database 132.

Server 130 may be configured to interact with computing device 110 and/or database 132. In some embodiments, server 130 may further be configured to manage one or more permissions associated with system environment 100. For example, server 130 may be configured to grant, track, monitor, store, revoke, validate, or otherwise manage permissions of various identities within system environment 100. While illustrated as a separate component of system environment 100, it is to be understood that server 130 may be integrated with one or more other components of system environment 100. For example, in some embodiments, server 130 may be implemented as part of computing device 110, or another device of system environment 100.

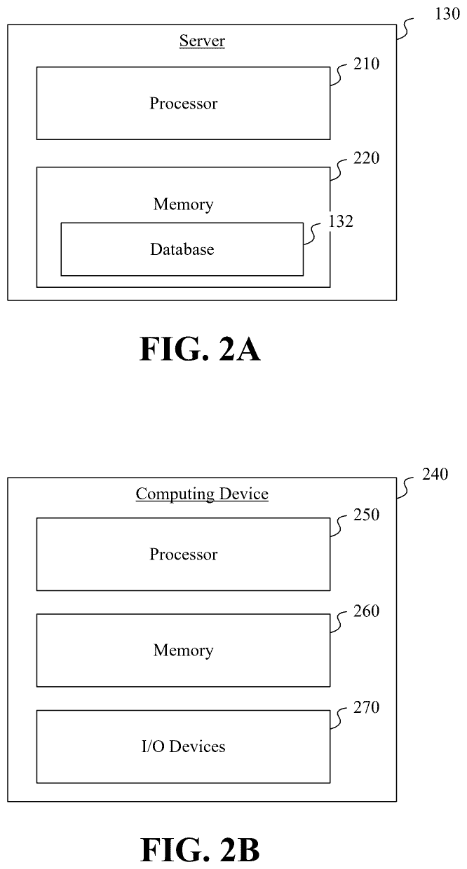

FIG. 2A is a block diagram showing an example server, consistent with the disclosed embodiments. For example, the server shown in FIG. 2A may correspond to server 130. As shown in FIG. 2A, permissions management server 200 (e.g., similar to server 130) may include a processor (or multiple processors) 230, a memory (or multiple memories) 240, and/or one or more input/output (I/O) devices (not shown), as shown in FIG. 2A.

Processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. The processor 210 may also be based on the ARM architecture, a mobile processor, or a graphics processing unit, etc. The disclosed embodiments are not limited to any type of processor configured in computing device 110 and/or server 130.

Memory 220 may include one or more storage devices configured to store instructions used by the processor 210 to perform functions related to computing device 110. The disclosed embodiments are not limited to particular software programs or devices configured to perform dedicated tasks. For example, memory 220 may store a single program, such as a user-level application, which performs the functions associated with the disclosed embodiments, or may comprise multiple software programs. Additionally, processor 210 may, in some embodiments, execute one or more programs (or portions thereof) remotely located from server 130. Furthermore, memory 220 may include one or more storage devices configured to store data for use by the programs. Memory 220 may include, but is not limited to a hard drive, a solid state drive, a CD-ROM drive, a peripheral storage device (e.g., an external hard drive, a USB drive, etc.), a network drive, a cloud storage device, or any other storage device.

In some embodiments, memory 220 may include a database or data structure 132 as described above. Database 132 may be included on a volatile or non-volatile, magnetic, semiconductor, tape, optical, removable, non-removable, or other type of storage device or tangible or non-transitory computer-readable medium. Database 132 may also be part of server 130 or may be accessed remotely. When database 132 is not part of server 130, server 130 may exchange data with database 132 via a communication link. Database 132 may include one or more memory devices that store data and instructions used to perform one or more features of the disclosed embodiments. Database 132 may include any suitable databases, ranging from small databases hosted on a workstation to large databases distributed among data centers. Database 132 may also include any combination of one or more databases controlled by memory controller devices (e.g., server(s), etc.) or software. For example, database 132 may include document management systems, Microsoft SQL™ databases, SharePoint™ databases, Oracle™ databases, Sybase™ databases, other relational databases, or non-relational databases, such as mongo and others.

FIG. 2B is a block diagram showing an example computing device 110, consistent with the disclosed embodiments. Computing device 110 may include one or more dedicated processors and/or memories. For example, server 130 may include a processor (or multiple processors) 250, and a memory (or multiple memories) 260, and one or more input or output devices (“I/O” devices) 270 as shown in FIG. 2B.

As with processor 210, processor 250 may take the form of, but is not limited to, a microprocessor, embedded processor, or the like, or may be integrated in a system on a chip (SoC). Furthermore, according to some embodiments, processor 250 may be from the family of processors manufactured by Intel®, AMD®, Qualcomm®, Apple®, NVIDIA®, or the like. Processor 250 may also be based on the ARM architecture, a mobile processor, or a graphics processing unit, etc. The disclosed embodiments are not limited to any type of processor configured in computing device 110.

Further, similar to memory 220, memory 260 may include one or more storage devices configured to store instructions used by the processor 250 to perform functions related to server 130/200. The disclosed embodiments are not limited to particular software programs or devices configured to perform dedicated tasks. For example, memory 260 may store a single program, such as a user-level application (e.g., a browser), that performs the functions associated with the disclosed embodiments or may comprise multiple software programs. Additionally, processor 250 may, in some embodiments, execute one or more programs (or portions thereof) remotely located from server 130 (e.g., located on server 130/200). Furthermore, memory 260 may include one or more storage devices configured to store data for use by the programs. Memory 260 may include, but is not limited to a hard drive, a solid-state drive, a CD-ROM drive, a peripheral storage device (e.g., an external hard drive, a USB drive, etc.), a network drive, a cloud storage device, or any other storage device.

Computing device 110 may further include one or more input/output (I/O) devices 270. I/O devices 270 may include one or more network adaptors or communication devices and/or interfaces (e.g., Wi-Fi, Bluetooth®, RFID, NFC, RF, infrared, Ethernet, etc.) to communicate with other machines and devices, such as with other components of system environment 100 through network 140. For example, computing device 110 may use a network adaptor to access various resources in system environment 100. In some embodiments, the I/O devices 270 may also comprise a touchscreen configured to allow a user to interact with computing device 110 and/or an associated computing device. The I/O device 270 may comprise a keyboard, mouse, trackball, touch pad, stylus, and the like.

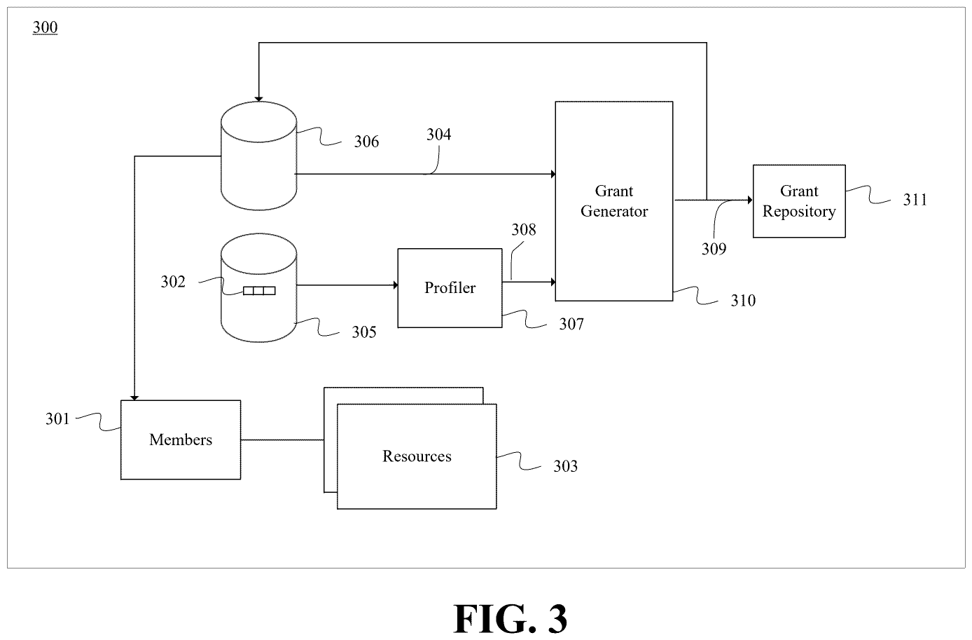

Referring to FIG. 3, an exemplary organization 300 includes members 301 who carry out different tasks in support of the organization's mission. Member or members may alternatively be referred to as user or users, respectively, throughout this disclosure. A member or user may include humans, or non-human identities, including service accounts coded automations and automated agents. In some embodiments, each member 301 may have certain attributes 302 that reflect that member's role in the organization 300. In some embodiments, examples of attributes 302 are “job title,” “department name,” “job code,” “manager,” or any other information associated with a member 301. In some embodiments, an organization may be continually updated, with members added or removed. In some embodiments, each member in an organization may have its attributes updated at any time, including updating, adding or removing attributes. In some embodiments, a member may be associated with only one organization. In some embodiments, a member may have no attributes.

A users'role in the organization 300 often requires the access to or exercise of certain resources 303. Examples of such resources include software applications or tools, platforms, databases, cloud apps, data-lakes or on-prem applications. In some embodiments, each such resource 303 may require a permission 304 to use. In some embodiments, each member 301 has a corresponding set of permissions 304, each of which may correspond to one of the resources 303. An authorization to use a resource may alternatively be referred to as an entitlement or permission to use the resource throughout this disclosure.

In some embodiments, it may be desirable to keep permissions 304 up to date. In some embodiments, keeping permissions up to date may promote information security. In some embodiments, disgruntled employees who leave while taking permissions 304 with them may be a threat to the organization's mission. In some embodiments, having obsolete permissions 304 may increase vulnerability to hacking, wherein when permissions are mismanaged, it is more likely that external or unnecessary parties have access to data that they should not have access to.

Because of the importance of keeping permissions 304 up to date, it is not uncommon for an organization 300 to be faced by periodic audits that relate to permissions 304. The auditor in such an audit may consider the methods used to maintain permissions 304. In some embodiments, having permission-maintenance methods that are easy to understand and deterministic in outcome tend to promote auditor confidence and may ease the burden of preparing for an audit. In some embodiments, with profile-based granting and monitoring, resources may also be saved by minimizing the approval process when new permissions are required for a profile group. For example, granting a profile grouping access to new software may only require one approval, while granting the same access to the same group of members individually may require thousands of manual approvals.

In some embodiments, the organization 300 may maintain both a member table 305 and a permission table 306. In some embodiments, tables can be maintained locally within the organization-including but not limited to firewall, dedicated server, or cloud. The member table 305 may identify each member 301 of the organization 300 and that member's attributes 302. The permission table 306 may provide, for each resource 303, a set of members 301 that are entitled to use that resource 303. The members included in the member table and in the permission table may overlap, where each member that is tracked with attributes are also tracked based on the resources that they currently have access to.

In some embodiments, for each member 301, a profiler 307 may define different profiles 308. Each of profiles 308 may consist of a subset of that member's attributes 302. Therefore, for each profile of profiles 308, there may exist a number of members 301 that have the attributes 302 defined by that profile. When a member has all of the attributes of the defined profile, they may be considered in the population of that profile, while also being part of the population of the greater organization. In some embodiments, a member may only be a part of the population of the organization. In some embodiments, a member may be a part of the population of many different profiles. The number of members 301 that have the attributes 302 defined by the profile 308 may be referred to herein as the profile's “population.” In some embodiments, a member 301 who contributes to the profile's population is said to “belong” to that profile or be a part of the population.

For example, a member 301 who works as engineer in quality assurance at a particular plant and who reports to a particular person would have three different attributes 302: “title,” “location,” and “manager.” Such a member 301 could be associated with several profiles 308, each with a different combination of these attributes 302. A profile 308 that consists of only one of these attributes 302 would take the form: “[title=QA Engineer].”

In some embodiments, because this profile 308 has only one attribute 302, one may expect it to have a large population. In general, as the number of attributes 302 in a profile 308 increases, its population decreases. In some embodiments, depending on its attributes 302, a profile's population can be anything between zero and the number of members 301 in the organization 300, the latter being referred to as the “null profile.” In some embodiments, a null profile may be used when all members 301 of the organization 300 are to be granted permission for a particular resource 303.

Since each profile 308 has a population of one or more members 301, it is possible to cover any desired fraction of the organization's members by defining a union of selected profiles 308. Such a union is referred to as a “cover.” The number of profiles 308 used to form the union is the “cover size.” Depending on how the profiles 308 are selected, it is possible to have different cover sizes. The goal then would be, for each resource 303, to identify a set of profiles 308 that covers a large fraction of those members 301 of the organization 300 who are entitled to use that resource 303.

While “cover size” refers to how many profiles are employed in one superset of the profiles, “coverage” of the profile may serve as a secondary metric for the union profile. Coverage may refer to the percent of members 301 in an organization 300 that are covered by a profile. For example, a profile may have a coverage of 80%, meaning that the profile currently covers 80% of members within the organization, while the profile may only be a union of two profiles, so the cover size is only 2. In some embodiments, combining these two metrics allows for an optimization to occur, where there is a balance between small cover size, employing less profiles, to execute with high coverage, or many of the members in the organization being accounted for in the union profile.

In some embodiments, there exist two special cases. If the profile 308 consists of attribute 302 that is by definition unique to a particular member 101, such as “employee ID,” the cover size would simply be 1, only one defined profile is being employed, while the coverage would be 100%, as all employees have a unique employeeID. On the other hand, if an attribute 302 such as “employee” is in a profile 108, the cover size would be unity, as all employees have the same value for this attribute, so no differentiation occurs. This would be the case for the foregoing “null profile.” Most organizations 300 are organized in such a way that one can cover nearly all the members 301 of the organization 300 with a surprisingly small number of profiles 308.

In some embodiments, for each profile 308 and for each resource 303, it is possible to consult the permission table 306 to determine which members 301 both belong to that profile 308 and have a permission 304 for that resource 303. Using this information, it is possible to create a “profile grant 309” that connects a profile 308 with a corresponding permission 304. A typical profile grant may include: “[GITHUB, R W] & [title=QA Engineer]”. In some embodiments, in this example, the profile grant 309 would grant the entire population of the profile “title=QA Engineer” read/write access to “GITHUB.” A profile grant may be created using a plurality of resources, to analyze permissions against members and existing profiles.

A profile grant 309 provides an automated way to grant a plurality of members 101 a particular permission 304 through one approval process. In cases where profile grants are not used, it may require many individual approvals in order to grant access to the same member group. By using profile grants, the disclosed method enables a much faster system for granting and managing permissions 304 compared to granting and managing permissions on a member-by-member basis. It is important to select the profile 308 for use in the profile grant 309 carefully. For example, not all profiles 308 are equally suited for use in generating a profile grant 309. Thus, it may be helpful to find an optimal set of profiles 308 to generate an optimal set of profile grants 309. A profile 308 that is used to develop a profile grant may be referred to as a candidate profile.

A variety of useful factors may help guide the decision of whether to generate a profile grant 309 using a candidate profile 308 or to disqualify the candidate profile 308. The factors used to determine the fit of a profile for a profile grant may serve as weights in choosing whether to use a candidate profile 308 for generating a profile grant 309. In some embodiments, the factors may be derived from the demographics of the profile population.

One example of a factor used for assigning a weight is an “entitlement count.” Entitlement count may refer to a representation of how many of members 301 who belong to the candidate profile 308 are in fact entitled to use the resource 303 in question. When nobody in the candidate profile 308 is entitled to use the resource 303, a profile grant 309 based on that profile 308 may be weighted very low. Conversely, the higher the entitlement count is, the more useful such a profile grant 309 is likely to be. In some embodiments, a default value may be assigned to the entitlement count, to allow for the entitlement count to be compared other entitlement counts or thresholds to determine the usefulness of the candidate profile being converted to a profile grant.

Another useful basis for assigning a weight to a profile grant may be the candidate profile's “birthright fraction.” Birthright fraction may refer to the fraction of the profile population that is entitled to use the resource 303 in question. Candidate profiles 308 with a birthright fraction of ninety-five percent are most attractive for use in generating a profile grant 309. However, if birthright fraction is low, it may cause the profile grant to be inaccurate and over allow for access to resources that members should not have access to.

Another basis for assigning a weight may be the minimum entitled population within the candidate profile 308. The minimum entitled population may be defined as the number of members 301 in the profile population who are entitled to use the resource 303 in question. When the minimum entitled population is lower than a pre-defined threshold, for example less than 50%, then a profile grant should not be used, as it would result in over allowing of resources to members that should not have access.

Another basis for assigning a weight may include a “false-alarm rate.” This may arise because, in some cases, examination of the member table 305 and the permission table 306 may indicate that the candidate profile's population includes a fraction that is not actually entitled to use the resource 303 in question. Thus, the “false-alarm rate” defines the fraction of members 301 in the profile population who are not entitled to use the resource 303 in question. When the “false-alarm rate” is anything larger than 0, it may indicate that some members 301 will be granted permission to use a resource 303 that they are not, in fact, entitled to use. Depending on the false-alarm rate and the sensitivity of the resource 303 in question, this error may be tolerable.

In some embodiments, a condition may be employed to prevent a profile 308 from being considered for use in a profile grant 309. Such a condition may be employed where a resource 303 is highly sensitive, such that any false-alarm rate could cause major security concerns. A condition may be provided or specified by a human administrator, or by a trained machine learning model.

Thus factors such as entitlement count, birthright fraction, minimum entitled population, or false-alarm rate may be used in the determination of profiles, either independently or in a certain combination. In some embodiments, these factors may be incompatible with each other. Furthermore, optimization of all of these factors may be difficult, as the conflict of conditions may impact how profile grants 309 are analyzed. Therefore, it may be helpful for an independent organization 300 to rank the importance of these factors when determining which candidate profiles to use to create profile grants. This ranking may be completed by the organization's human administrators and predefined, or may be done using a trained machine learning model that would allow for many factors to be input and ranked based on general conditions rather than just the predefined factors. For example, when using a trained machine learning model to perform ranking of the factors, the organization may be able to specify that it values a highly accurate method, with unlimited processing power, and thus metrics would be sent based on the agent, to the relevant factors, in comparison to being able to set predefined factors without the use of trained machine learning models.

Other examples of conditions that may arise in generating profile grants 308 include limits on the number of profile grants 308 that can be used. Thus, for example, profile grants 308 may be ranked and only those that have scores greater than or equal to a threshold score may be available for use. In some embodiments, profile grants that achieve higher scores may be prioritized to maintain minimal resource undertaking and audit resources. The scoring of a profile grant may be completed based on the accuracy of the grant, considering it's false-alarm rate, birthright, minimum profile grant, entitlement count, and/or some combination thereof. In some embodiments, the score for each profile grant may be updated as the system is updated with new resources, or new members.

By setting the default values for one or more of the foregoing factors, an organization 300 may be able to tune the process of generating profile grants 309 to suit its needs with considerable specificity. Selecting profiles 308 used to generate profile grants 309 by inspection of the demographic characteristics of the organization's membership may lead to the practical application of generating an objective basis for automatically granting permissions 304 for use of the objective basis in connection with a permission audit.

In some embodiments, it may be desirable to use the smallest possible number of distinct profiles 308 and the smallest possible number of profile grants 309 that collectively provide an objective explanation for as many permissions 304 as possible. To promote simplicity, it may be useful for the profiles 308 to have as few attributes 302 as possible. Having a small number of profiles 308 and profile grants 309 may make the process of granting permissions 304 easier to explain to auditors.

In some embodiments, the explanation for granting permissions 304 to a set of members 301 is based on two or more profile grants 309. In some embodiments, it may be preferable if the profile populations of the corresponding profiles 308 used to generate those profile grants 309 do not overlap, or if they do, that they overlap as little as possible.

In some embodiments, the profiles 308 and the permissions 304 may be provided to a grant-generating component 310 that can search for a set of profiles 308 that comes as close as possible to including all members 301 in the organization 300 but subject to certain conditions that are imposed by the relationships between the demographics of the profile populations and their corresponding permissions 304 obtained from the permission table 306. In some embodiments, the grant-generating component 310 may perform the analysis through a variety of different procedures, including through trained machine learning models.

In some examples, permissions or entitlements might not have been assigned to any users and are therefore not associated with any users. Such permissions or entitlements are being referred to as orphaned permissions.

In some embodiments, the grant-generating component 310 may learn a suitable set of profile grants 309 by traversing a solution space to find incrementally preferred combinations of profiles 308 and profile grants 309. In some embodiments, grant-generating component 310 may adopt a Bayesian approach or to carry out simulated annealing, in order to promote movement towards a global optimal solution, to, in turn reducing the risk of entrapment by a local optimal solution. In some embodiments, profile grants 109 thus generated may be saved in a grant repository 311 for use in case of an audit.

In some embodiments, the grant-generating component 310 is a non-generic digital computer that has been specially modified to carry out solutions to weighted cover problems. In other embodiments, the grant-generating component 310 is implemented as an application-specific integrated component.

In some embodiments, the grant-generating component 310, may use a machine-learning model, providing clearly explainable results, and consistency in processing results such that a machine-learning model reliably leads to the same optimal set of profile grants 309. The deterministic nature of the solution likewise leads to the practical result of promoting auditor confidence.

Consistent with the disclosed embodiments, the machine learning model may be a large language model (LLM) configured to perform natural language processing (NLP) tasks and generate text outputs. In some embodiments, the machine learning model may additionally or alternatively include or be based on a logistic regression, a linear regression, a random forest, a K-Nearest Neighbor (KNN) model, a K-Means model, a decision tree, a cox proportional hazards regression model, a Naïve Bayes model, a Support Vector Machines SVM) model, a gradient boosting algorithm, a deep learning model, or any other form of machine learning model or algorithm. In some embodiments, the machine learning model may be trained using labelled training data, or historical data to fine-tune the model. In some embodiments, the machine learning model may be continuously fed with feedback generated from prior uses of the machine learning model to improve its performance and validity. For example, various feedback loops may be implemented to feed data back to a model database for training and fine-tuning the machine learning model. In some embodiments, using trained machine learning models in the disclosed embodiments creates a repeatable process that can be easily audited. The trained machine learning models deployed, may be deployed locally to protect against security or privacy concerns.

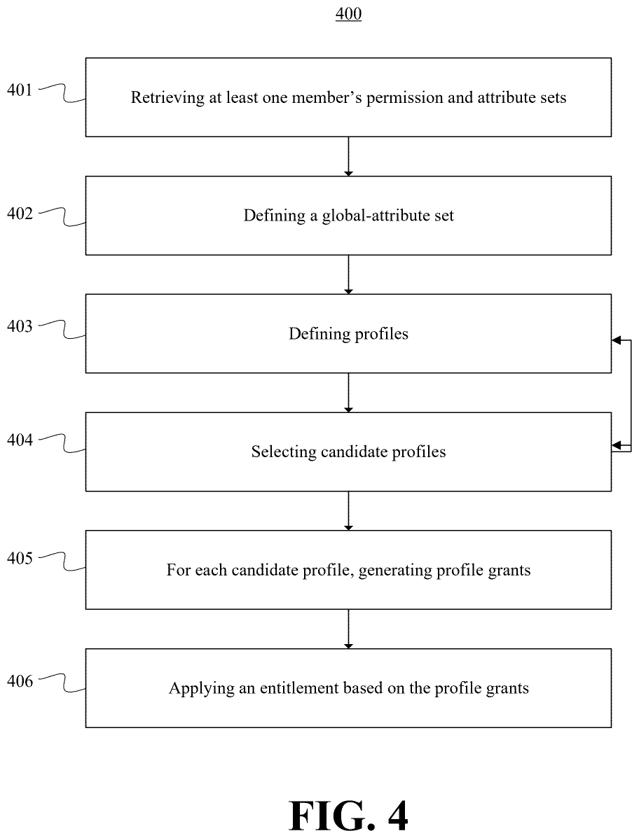

FIG. 4 illustrates an exemplary method 400 for generating member permissions profiles. The order and arrangement of steps of method 400 is provided for purposes of illustration. As will be appreciated from this disclosure, modifications may be made to method 400 by, for example, adding, combining, removing, and/or rearranging the steps of method 400. Method 400 may include any combination of retrieving a member's permission and attribute set, defining global-attribute set, defining profiles, selecting candidate profiles, generating profile grants, and selecting a profile grant. configured in any order. Step 401 may include identifying at least one member's permission set and at least one attribute set. In some embodiments, at least one member's permission and attributes of a plurality may already have been identified. In some embodiments, once a member's permissions and attributes are identified, they can be stored to not require identification again. In some embodiments, when a member's permissions and attributes are already stored, the identifying may include updating the member's permissions and attributes. In some embodiments, the user permissions and attributes may come from external data sources, including human resources systems and application logs.

Step 402 may include defining a global-attribute set. In some embodiments, step 402 may occur after the identification step 401. In some embodiments, the member information, including permissions and attributes that have been identified or are stored may be used to create global-attribute sets. For example, a global attribute set may be the union of multiple member's attributes and permissions, including all the possible attributes that may be associated with a member, and all the possible permissions that may be associated with a member. In some embodiments, the global-attribute set may be configured to be dynamic. For example, each time a new member is added, removed, or their information is changed, the global attribute set may be updated, wherein the more frequently the global attribute set is updated to align with the members, the more accurate the successive steps and their results may be. In some embodiments, the global-attribute set may be used to analyze all of the member information and create a high level summary or grouping of the member information, that is now processable as member data. For example, the global-attribute set may be stored in a created table, such that all of the member information in an organization is stored together, wherein various analysis can be completed including determining how many members fall into each attribute group, have certain permissions, or share a combination of attributes or permissions.

Step 403 may include defining profiles. In some embodiments, step 403 may occur following the definition step in 402. A profile may be defined as at least one attribute mapped to at least one permission, wherein an attribute or list of attributes often is linked to certain permissions, and thus in creating a profile, it allows the method to identify that if a member has an attribute or a set of attributes, the member should also have the permissions indicated by the profile. In some embodiments, defining profiles may include analyzing the member data from the global-attribute set and grouping the data based on shared attributes and shared permissions. A profile may be defined based on the existing data in the global attribute set, such that groupings of members with both shared attributes and shared permissions are created. In the event that members that share attributes and permissions are identified, it may be concluded that in future instances, when an additional member has all of the same attributes, the member should also be granted such permissions-thus a profile is created. A profile may be created as a template or framework for mapping member attributes to member permissions. For example, in a global-attribute set, all members that have the job title “Engineer” and work location “Washington DC”, have permission to access internal document “A”, thus profile is created, identifying the relationship between “Engineer” and “Washington DC” with document “A” access. In the event that a new employee is hired and added to the system with attributes “Engineer” and “Washington DC”, the profile now informs the system that this employee should likely be granted access to Document “A”. In some embodiments, initially defining a profile may include using trained machine learning models to sort through the data and optimize the creation of groupings with ideal factors. For example, machine learning models may be used to create groupings of attributes that are most definitive in permissions associated, testing all the possibilities of attribute combinations and ranking which profiles create value, in comparison to minimal value add profiles. A profile may be deemed minimal value if it is too broad, or when a profile suggests granting access to a member set, when it should not grant those permissions to the member set, as it may result in over-allowing permission to certain resources. In some embodiments, one or more trained machine learning models may be employed to create the profiles. In some embodiments, the trained machine learning models may go through and enumerate every attribute about the users and test the importance of every possible combination of attributes mapped to permissions. The model may then be able to understand all of the possible profile combinations and determine which are the most effective to and provide the greatest coverage. Coverage may refer to the idea that majority of the organization's members and their permissions are accounted for by a set number of profiles. In some embodiments, the data provided to the trained machine learning models may be pre-processed to allow an optimized configuration of the model. For example, when creating a profile, titles and departments may be considered high order items that are frequently used and never considered. Additionally, profiles may never be determined based on the attribute “manager” because relying on the user's manager may generate a small number of profiles determined based primarily on the users'manager. However, users should have access (e.g., entitlements) to resources based on who they are and what they do, not necessarily based on who they work for. Thus, ignoring titles, departments, and/or managers during profile generation may be examples of default conditions imposed on the machine learning models. It should be understood that other user attributes may be included in the default conditions. Similarly, in some embodiments, one or more of attributes such as titles, departments, and/or managers may not be included in the default conditions. As described below, these default conditions may be modified by a human administrator or a trained machine learning model.

Step 404 may include selecting candidate profiles. In some embodiments, step 404 may occur following the definition in step 403. In some embodiments, selecting candidate profiles may include identifying which profiles from step 403 provide the most value. In some embodiments, to identify which profiles provide the most value, scoring algorithms may be used, in which default parameters may be set or organizations can set their own based on organizational requirements. Scoring algorithms may be implemented using one or more Large LLMs and parameters based on a variety of factors, including but not limited to how many candidate profiles may be supported, or how effective a candidate profile must be in order to move into profile grant stages. Based on the scoring algorithm outputs, a candidate profile may be defined as one that can provide value if implemented as a profile grant, such that a candidate profile is selected from the initial profile list created. When a candidate profile receives a high score via the scoring algorithm, that may indicate that its implementation would likely be successful, minimizing negative factors, like false-alarm rates, and minimum entitled populations. In implementing a scoring system, with parameters, many different parameters may be useful in considering which candidate profiles should be scored most highly.

The scoring algorithm may be set up to take the input in the form of the global-attribute set or the predefined profiles, and any parameters the organization chooses to set, and output a ranking of candidate profiles that may be considered for converting to profile grants. Some parameters may include, for example, entitlement counts, wherein an entitlement count may be based on how many members in the profile are currently permissioned to the resource or resources related to the profile. In some cases, the relationships between attributes and permissions are not always 1:1, so when creating a profile, the profile may over permission certain members, based on applying the profile too broadly. To avoid this issue, a parameter may be set to determine the maximum amount of false permissioning that can occur by the profile before the profile is deemed unfit for use, or receives a low score. Another parameter may include, for example, birthright fraction, wherein birthright fraction refers to the fraction of members in the profile that are permissioned to use the resources accounted for in the profile. This parameter is opposite of the parameter related to entitlement count, where there may be a minimum number of members in an organization that should be getting the correct permissions. In some instances, it may make sense to only set one of the two above parameters, to minimize conflicting values governing the scoring. In some embodiments, the parameter may include, for example, minimum entitled population, wherein minimum entitled population of a candidate profile represents how many members in said candidates are entitled to use the resource. This parameter may be related to the birthright fraction, such that only one parameter may be required to be set in order to proceed with scoring.

In some embodiments, the parameter may include, for example, a false alarm rate, wherein false alarm rate refers to which fraction of the member pool would get access to resources they should not have access to in the case that this profile is used. In this case, different resources may have different false alarm rates associated with them, as some resources may be more sensitive than others to members receiving unintended access. In some cases, setting a maximum false alarm rate may be helpful to determine how a profile should be scored to avoid adverse events.

In some embodiments, disqualification may be used in the scoring or selection criteria for candidate profiles. Disqualification may refer to the idea that certain candidate profiles may be unusable based on certain attributes that the scoring or selection models have been conditioned to look for. For example, some resources may be flagged to not be implemented in the profiling set because they are too expensive or have too many security concerns, such that any candidate profile that intends to grant access to these predetermined resources are automatically removed from candidate profile candidacy.

In some embodiments, limits on how many candidate profiles may be selected and used in profile granting may impact how scoring is completed. Some systems may only be able to support a minimum amount of profile grants, so profile grants with high statistics or scores may be prioritized for granting.

In some embodiments, not all profiles identified in step 403 may be implemented as profile grants to minimize computing power, and only implement profiles that have large scale applications across the organization. For example, if a profile only applies to two members of the organization, it may not make sense to implement that candidate profile further in the method, as creating the profile grant, and further maintenance and monitoring may require valuable computing resources.

Step 405 may include generating profile grants for the selected candidate profiles. In some embodiments, step 405 may occur following the selection in step 404. In some embodiments, generating a profile grant may include assigning permissions to attributes such that when a member with the selected list of attributes is identified, the permissions may be applied to that user. As defined above, a profile differs from a profile grant. In the instance that a profile is defined, it may not be put into execution, as there may be limited support for the number of profiles that can be implemented. In the case that a profile is chosen as valuable based on the scoring mechanism via the candidate profile selection step 404, the profile may be adapted to become a profile grant. A profile grant supports the same relationship between attributes and permissions but is configured to implement permission updates based on attributes, while a profile is only an indication of the relationship between attributes and permissions. In some embodiments, when generating a profile grant for a selected candidate profile, many factors as disclosed above, including, for example, birthright fractions, entitlement counts, minimum entitled populations, or false-alarm rates may be relied upon to determine which permissions should be included in the profile grant.

In some embodiments, once scoring of the candidate profiles are complete, a threshold score may be implemented to determine which candidate profiles are implemented as profile grants. In such cases, using the scoring method of step 404, only candidate profiles above an overall score may be selected and used to create profile grants for further processing. In some embodiments, once scoring of the candidate profiles is complete, a threshold rank may be implemented to determine which candidate profiles are implemented into profile grants. In such cases, using the scoring method of step 404, candidate profiles may be ranked based on their scores relative to one another, and only candidate profiles above a certain threshold rank may be selected and used to create profile grants for further processing. In some embodiments, profile grants may be selected to minimize overlap between profile grants, such that diverse profile grants are prioritized in order to reach the maximum amount of members. If two candidate profiles are very similar in the member populations that they support, it may be of high value to the organization to implement a more diverse set of profile grants.

Step 406 may include applying the entitlement to the member based on the profile grants. In some embodiments, step 406 may occur following the generating step in 405. In some embodiments, selecting the profile grant may include using the member's permissions and attributes to determine which profile grants that have been created by the organizational data apply to the current member. In some embodiments, if there are profile grants that are only partially applicable to a member based on the attributes, selecting the profile grant may include choosing which profile grants should be implemented, by weighing the risk and reward of over profiling a member. In some embodiments, when a profile grant is selected, the selection may be dynamic, in which the member's attributes and permissions may change, and the organizations defined profile grants may change, and as such, the selected profile grants may be configured to adjust accordingly.

In some embodiments, trained machine learning models may be employed to select the profiles. The trained machine learning model that is employed may be the same trained machine learning model used in previous steps, or an additional trained machine learning model. In some embodiments, the trained machine learning models may optimize, based on the scoring, which profile grants are most beneficial to the system. In using a trained machine learning model to determine scoring and ranking of profiles and their associated grants, efficiency of the system of a whole may be increased greatly.

In some embodiments, steps 403, 404, and 405 may be iterative with one another, where when profiles are created and scored, or tested, then the results are sent back to the step 403 to further tune the way in which profiles are being created either for the next user, or the next project, thus creating a feedback loop. This flow can be seen as a training process using training data, wherein as profiles are weak they are sent back through the loop to be strengthened, but profiles that are strong pass to the next step. In some embodiments, a human administrator or a trained machine learning model. may provide one or more condition to the machine learning models, which in turn may generate the profiles (step 403) and/or profile grants (step 405) based on the received conditions. The process of generating profile grants may be iterative. For example, the machine learning model may start with a default set of conditions such as ignoring titles, departments, and/or managers. The machine learning model may generate a set of profiles and derive a set of profile grants as described in this disclosure. A human administrator may review the profile grants and add or modify the conditions. The machine learning model may revise the set of profiles and/or profile grants based on the revised set of conditions. This process may be iteratively repeated until the human administrator is satisfied with the generated profiles and profile grants. In some embodiments, the tasks performed by the human administrator may additionally or alternatively be performed by a trained machine learning model, that can be the same machine learning model or an additional one

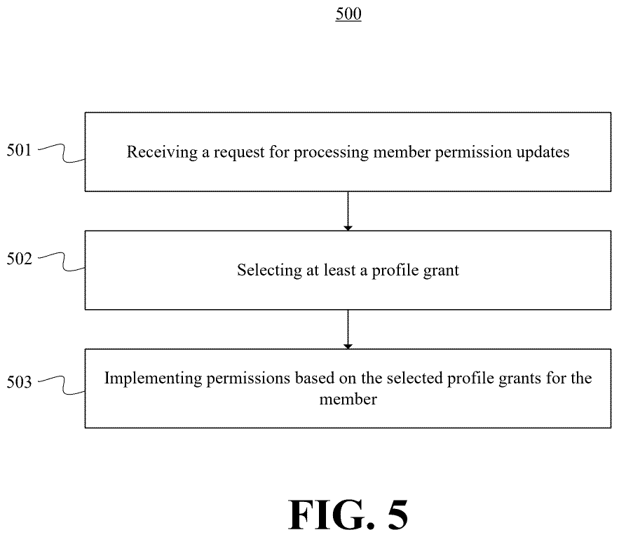

FIG. 5 illustrates an exemplary method 500 for determining member permissions and granting permissions based on profiles. The order and arrangement of steps of method 500 is provided for purposes of illustration. As will be appreciated from this disclosure, modifications may be made to method 500 by, for example, adding, combining, removing, and/or rearranging the steps of method 500. Method 500 may include any combination of receiving a request for processing member permission updates, selecting at least a profile grant, and implementing permissions based on the selected profile grants for the member, configured in any order.

Step 501 may include receiving a request for member permission updates. In some embodiments, a member's permissions may need to be updated, based on changes to the member's attributes, to the member's permissions, to new profile creation, or to new resources being added to the system. In some embodiments, a member may request access to a new resource, which may trigger a request for that member's permission updates. In some embodiments, a request for member permission updates may be initiated by any member of the organization. In some embodiments, a request for member permission updates may be initiated at a certain timely cadence in order to keep permissions as up to date as possible.

Step 502 may include selecting at least a profile grant that is relevant to the member permission request from step 501. In some embodiments, this step may include the use of trained machine learning models. When a user request is made, and their permissions need to be updated, the attributes of the user, along with the user's existing permissions may be identified in order to feed them into the trained machine learning model. In some examples, when a set of attributes appears, the machine learning model is able to determine which combinations of attributes are associated with which profile grants, and which profile grants should apply specifically for that user. This determination may be completed by the process disclosed in method 400.

Step 503 may include implementing the profile grants for the member or members. In some embodiments, step 503 may occur following the selection in step 502. In some embodiments, the profile grants that may have been selected based on the member attributes, may be initiated to enforce the permissions that have been selected by selecting the profile grant. In some embodiments, initiating the profile grant may allow for a user approval, creating a summary of new permissions, or revoking permissions, and receiving an approval from a human before the permissions for that member are updated. In some embodiments, the chosen profile grants may be need to be approved by designated resource or application owners prior to activation, implementing a federated approval workflow. In some embodiments, the implementation of profile grants may include the use of trained machine learning models. For example, once at least a profile grant is selected in step 502, the profile grant needs to be implemented for the user, and the permissions granted accordingly. Based on the input from the profile grant(s) chosen, the trained machine learning model can grant the necessary permissions to the user that is specified. The trained machine learning model may also be configured to concurrently identify member-permission sets that do not correspond to active members, or orphaned permissions, and to initiate remediation actions to resolve these orphaned permissions, either by removing the permissions or by including them in one or more profile grants. In some embodiments, the trained machine learning model may be configured to continuously monitor member-permission sets and profile grants to identify and remediate over-permissioned members or groups, thereby enforcing least privilege, by removing permissions that should not be associated with the users they are currently associated with. For example, the machine learning model may be configured to determine profiles and generate profile grants that do not include those permissions (or entitlements).

In some embodiments, the results of the profile granting methods in 400 and 500 may automatically generate audit evidence packages documenting the application of the profile grants to member-permission sets for compliance review. For example, a summary of which attributes were tested and ranked, which attributes were chosen, how profiles were determined based on the attributes, how profile grants were generated for candidate profiles, and how the profile grants were applied to one or more users may be included in the audit evidence package. In some embodiments, the methods disclosed in 400 and 500 may be deployed locally, as to avoid security concerns.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

A number of implementations have been described. Nevertheless, it will be understood that various modifications may be made without departing from the spirit and scope of the disclosure. Accordingly, other implementations are within the scope of the following claims.

It is understood that the described systems or apparatuses are not mutually exclusive, and elements, components, materials, or steps described in connection with one example method, system, or apparatus may be combined with, or eliminated from, other disclosed methods, systems, or apparatuses in suitable ways to accomplish desired design objectives.

In the foregoing specification, the disclosed systems or apparatuses have been described with reference to numerous specific details that can vary from implementation to implementation. Certain adaptations and modifications of the described systems or apparatuses can be made. Various renditions of the disclosed systems or apparatuses can be apparent to those skilled in the art from consideration of the specification and practice of the invention disclosed herein. It is intended that the specification and examples be considered as exemplary only.

It should be understood that the various embodiments described herein are not mutually exclusive and may be combined, modified, or interchanged in whole or in part without departing from the scope of the disclosed technology. Features illustrated or described in connection with one embodiment may be incorporated into other embodiments to form additional implementations. Accordingly, the disclosed technology encompasses all such combinations and variations that fall within the spirit and scope of the appended claims.

What is claimed is:

1. A method for controlling access to a resource, the method comprising:
for each user in an organization, identifying a user-attribute set and a user-permission set, wherein the user-attribute set comprises at least one attribute of the user and wherein the user-permission set includes information associated with an entitlement to use the resource;
defining a global attribute-set, the global attribute-set being a union of the one or more user-attribute sets;
determining, using a machine learning model, a set of profiles, each profile in the set of profiles including a subset of the global attribute-set;
selecting one or more candidate profiles from the set of profiles;
for each of the candidate profiles, generating a first profile grant, wherein the first profile grant defines, for each user associated with the candidate profile, an entitlement to use the resource; and
assigning the entitlement to the user based on the first profile grant.

2. The method of claim 1, further including:
receiving at least one condition as input;
updating, using the machine learning model, the set of profiles based on the at least one condition;
selecting the one or more candidate profiles from the updated set of profiles; and
for each of the selected candidate profiles, regenerating the first profile grant based on the at least one condition.

3. The method of claim 1, further including:
identifying that a user-permission set requires processing;
based on the user-attribute set of the user, identifying a second profile grant; and
using the second profile grant to process the user-permission set.

4. The method of claim 1, wherein selecting the one or more candidate profiles is based on entitlement counts of the one or more candidate profiles.

5. The method of claim 1, wherein selecting the one or more candidate profiles is based on birthright fractions of the one or more candidate profiles.

6. The method of claim 1, wherein selecting the candidate profiles is based on minimum entitled populations of the candidate profiles.

7. The method of claim 1, wherein selecting the candidate profiles is based on false-alarm rates of the candidate profiles.

8. The method of claim 1, wherein selecting the candidate profiles includes disqualifying a profile from being a candidate profile based on the profile including a particular attribute.

9. The method of claim 1, wherein the candidate profiles are selected based on a limit on a number of profile grants.

10. The method of claim 1, wherein selecting the candidate profiles further comprises ranking profile grants derived from the candidate profiles and selecting the candidate profiles having ranks above a threshold rank.

11. The method of claim 1, wherein selecting candidate profiles comprises scoring profile grants derived from the candidate profiles and selecting the candidate profiles having scores above a threshold score.

12. The method of claim 1, wherein selecting candidate profiles is based on a level of overlap between profile grants.

13. The method of claim 1, wherein the profile includes at least one user having at least one attribute included in a superset of the attributes defined in the profile, wherein the set of profiles, in aggregate, covers a predefined subset of the users.

14. The method of claim 1, wherein the processing of a user-permission includes one of creation and modification of the user-permission set.

15. A system for controlling access to a resource in a resource set to improve grant accuracy the system comprising:
a memory storing instructions; and
at least one processor configured to execute the stored instructions to:
for each user in an organization, identify a user-attribute set and a user-permission set, wherein the user-attribute set comprises at least one attribute of the user and wherein the user-permission set includes information associated with an entitlement to use the resource;
define a global attribute-set, the global attribute-set being a union of the one or more user-attribute sets;
determine, using a machine learning model, a set of profiles, each profile in the set of profiles including a subset of the global attribute-set;
select one or more candidate profiles from the set of profiles;
for each of the candidate profiles, generate a first profile grant, wherein the first profile grant defines, for each user associated with the candidate profile, an entitlement to use the resource; and
assign the entitlement to the user based on the first profile grant.

16. The system of claim 15, wherein the processor is further configured to automatically generate an audit evidence package documenting the application of the profile grants to user-permission sets for compliance review.

17. The system of claim 15, wherein the processor is further configured to implement a federated approval workflow, wherein profile grants are subject to approval by designated resource or application owners prior to activation.

18. The system of claim 15, wherein the processor is further configured to dynamically update profiles and profile grants in response to changes in use attributes, organizational structure, or resource set composition.

19. The system of claim 15, wherein the processor is further configured to identify user-permission sets that do not correspond to active users and to initiate remediation actions to resolve orphaned permissions.

20. The system of claim 15, wherein the processor is further configured to continuously monitor user permission sets and profile grants to identify and remediate over-permissioned users or groups, thereby enforcing least privilege.

21. The system of claim 15, wherein the processor is further configured to integrate with external data sources, including human resources systems and application logs, to retrieve user attributes and permissions.

22. The system of claim 15, wherein the processor is further configured to retrieve and process attribute sets and permission sets for non-human identities, including service accounts and automated agents.

23. The system of claim 15, wherein the processor is further configured to automatically manage user-permission sets in response to lifecycle events, including one or more of onboarding, role changes, and offboarding of users.

24. The system of claim 15, wherein at least one of defining a global attribute-set, determining the set of profiles, selecting the one or more candidate profiles, and generating the first profile grant is done with a trained machine learning model.

25. The system of claim 24, wherein the trained machine learning model uses a combination of data processing and optimization techniques to enumerate all possible combinations of attributes mapped to permissions.

26. The system of claim 24, wherein the at least one processor is configured to use a plurality of trained machine learning models to execute the stored instructions.

27. The system of claim 24, wherein the trained machine learning model is trained using historical data.

28. The system of claim 15, further comprising a pre-processing step that uses the trained machine learning model to exclude attributes that are not weighted with high importance.

29. The system of claim 15, wherein using trained machine learning models creates a repeatable process that can be easily audited.

30. The system of claim 24, wherein the trained machine learning models can be deployed locally for at least one of privacy and security.

31. A non-transitory computer readable medium having computer executable instructions embodied that, when executed by at least one processor of a computing system, cause the computing system to perform operations for controlling access to a resource in a resource set in order to improve grant accuracy the operations comprising:
for each user in an organization, identifying a user-attribute set and a user-permission set, wherein the user-attribute set comprises at least one attribute of the user and wherein the user-permission set includes information associated with an entitlement to use the resource;
defining a global attribute-set, the global attribute-set being a union of the one or more user-attribute sets;
determining, using a machine learning model, a set of profiles, each profile in the set of profiles including a subset of the global attribute-set;
select one or more candidate profiles from the set of profiles;
for each of the candidate profiles, generate a first profile grant, wherein the first profile grant defines, for each user associated with the candidate profile, an entitlement to use the resource; and
assign the entitlement to the user based on the first profile grant.
